(19) United States
(12) Patent Application Publication
(10) Pub. No.: US 2020/0300315 A1
(43) Pub. Date: Sep. 24, 2020

(54) RESTRICTING DEVICE FOR RESTRICTING BRAKE ROTOR FROM ROTATING DURING MAINTENANCE

(71) Applicants: KYLE LIU, TAICHUNG CITY (TW); ISHIHARA YOUZOU, Tsushima-shi (JP)

(72) Inventors: KYLE LIU, TAICHUNG CITY (TW); ISHIHARA YOUZOU, Tsushima-shi (JP)

(21) Appl. No.: 16/893,349

(22) Filed: Jun. 4, 2020

Related U.S. Application Data
(63) Continuation-in-part of application No. 16/165,032, filed on Oct. 19, 2018.

(51) Int. Cl. F16D 65/00

(52) U.S. Cl. CPC F16D 65/0043

(57) ABSTRACT

A restriction device includes a bridge including a connection portion and a locking portion respective formed on two ends thereof. The connection portion includes a protrusion on the first side of the bridge. The protrusion is to be connected to connection parts on the hub. The locking portion includes a tubular part on the second side of the bridge. The tubular part is located between the hub of the disk body and the brake caliper. The tubular part contacts one of two ends of the brake caliper to restrict rotation of brake disk.

The present invention is a Continuation-In-Part application of applicant's former patent application with the application Ser. No. 16/165,032, filed on Oct. 19, 2018.

### BACKGROUND OF THE INVENTION

### 1. Fields of the Invention

### 2. Descriptions of Related Art

JP 2000-274511 discloses a differential which is connected to two axles that are respectively connected to two wheels. A set of gears secures the differential by bolts. The set of gears transfers the output energy from the engine to the differential so as to drive the wheels. JP2000-274511 provides a device that replaces the differential and includes a portion that is connected to the set of gears, and another portion that is connected to the axles so as to restrict rotation of the axles.

When the bolts are to be removed, the axles rotate freely, this requires one person to secure the brake rotor that is connected with the axle, and another person to remove the bolts. In other words, this task requires two persons to finish and therefore reduces the efficiency or work.

U.S. Pat. No. 9,376,300 discloses an end piece of wheel cylinder piston adjustor and which discloses two rock arms which are pivotably located between a seat body and a guide body. The guide body includes two slots. Each rock arm has a pin-shaped locating body which movably extends through the slot corresponding thereto. The rock arm is pivotably connected along the periphery of the seat body. When moving the pin-shaped locating bodies along the two slots, the distance between the pin-shaped locating bodies is adjusted.

The end piece is used to push the wheel cylinder piston back into the piston room for replacing the worn linings with new ones.

The present invention is intended to provide a restriction device that is installed to the brake rotor so as to restrict rotation of the shaft and the brake disk of the brake rotor to eliminate the drawbacks mentioned above.

### SUMMARY OF THE INVENTION

The present invention relates to a restriction device for restricting brake rotor from rotating. The brake rotor 30 includes a brake disk which includes a disk body and a hub which protrudes axially from the center of the disk body. A brake caliper is mounted to outside of the disk body and overlapped a portion of the disk body. The brake caliper is cooperated with brake pads which are located between the brake disk and the brake caliper. The hub includes multiple connection parts. The restriction device comprises a bridge including a connection portion and a locking portion respective formed on two ends thereof. The connection portion has a protrusion which extends from the first side of the bridge and is adapted to be connected to connection parts of the hub. The locking portion has a tubular part which is connected to the second side of the bridge. The tubular part is configured to be located between the hub of the disk body and the brake caliper. The tubular part is configured to contact one of two ends of the brake caliper to restrict rotation of brake disk.

Preferably, a locking member extends through the bridge and is connected to the tubular part.

Preferably, the bridge includes a first hole and a second hole defined therein. The first hole is located corresponding to the protrusion. The second hole is located corresponding to the tubular part. The locking member extends through the second hole and is connected with a nut.

The present invention requires only one person to remove bolts of the brake rotor.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the restriction device of the present invention;

FIG. 2 shows the wheel drive system of a vehicle;

FIG. 3 illustrates the brake rotor and brake caliper of a vehicle;

FIG. 4 shows the restriction device of the present invention is installed to the brake rotor;

FIG. 5 shows that the tubular part of the restriction device of the present invention contacts one of two ends of the brake caliper, and

FIG. 6 shows that the tubular part of the restriction device of the present invention contacts the other one of two ends of the brake caliper.

### DETAILED DESCRIPTION OF THE PREFERRED EMBODIMENT

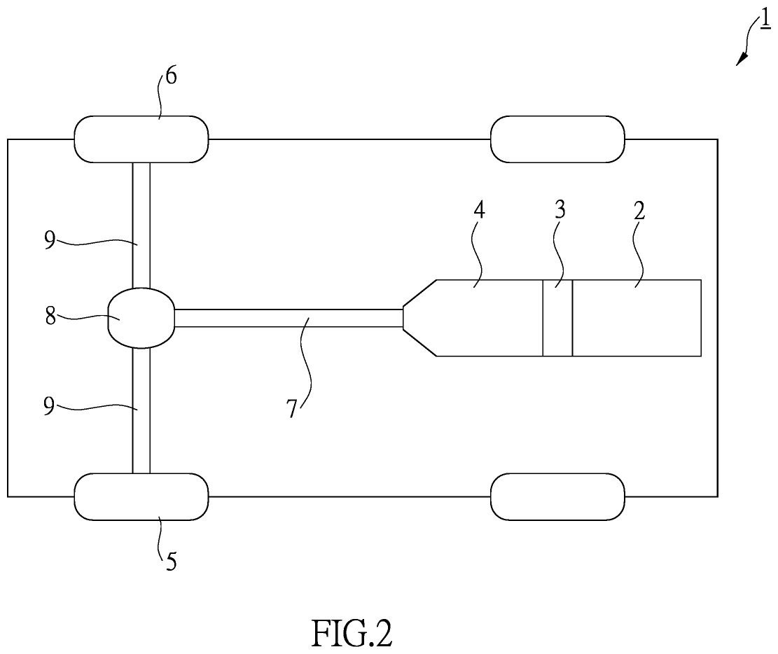

Referring to FIG. 2, the wheel drive system of a vehicle 1 includes an engine 2, a clutch 3, a drive shaft 7 and a transmission 4. A differential 8 is connected to the drive shaft 7, and the differential 8 is connected to two wheels 5, 6 by two axles 9.

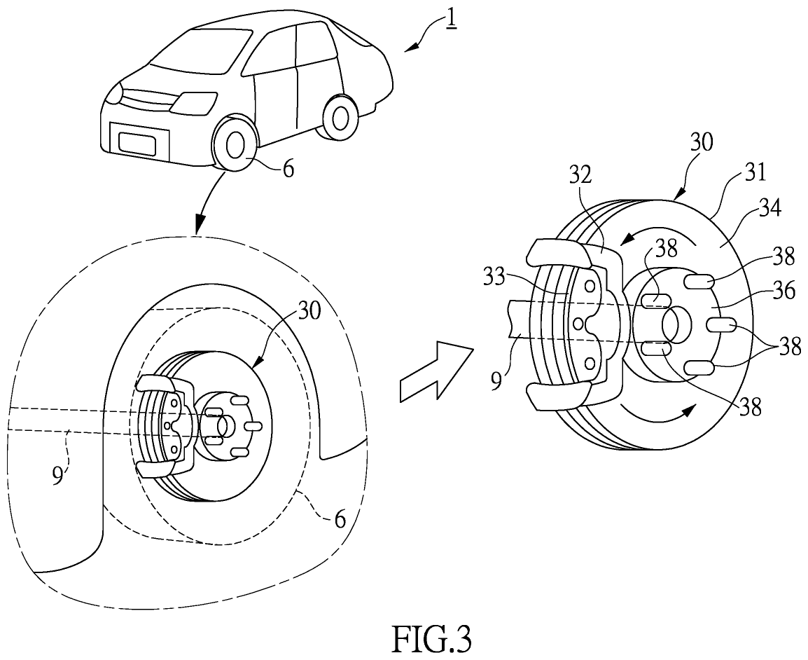

As shown in FIG. 3, each wheel 5/6 is cooperated with a brake rotor 30 which are driven by hydraulic cylinders to brake the vehicle 1. The output of the engine 2 is transferred to the drive shaft 7, and the differential 8 receives the power from the drive shaft 7 and drives the two axles 9 to rotate the two wheels 5, 6.

The brake rotor 30 as shown in FIG. 3 includes a brake disk 31 which includes a disk body 34 and a hub 36 protrudes axially from the center of the disk body 34. A brake caliper 32 is located outside of the disk body 34 and is cooperated with brake pads 33 which are used to stop the rotation of the brake disk 31. The thickness of the hub 36 is larger than that of the brake disk 31. The brake caliper 32 is mounted to a portion of the brake disk 31 and the brake pads 33 are located between the brake disk 31 and the brake caliper 32 so that when the brake caliper 32 is activated, the brake pads 33 are moved to touch the brake disk 31 to stop the wheel 5/6. The hub 36 includes multiple connection parts 38 which include bolts and nuts.

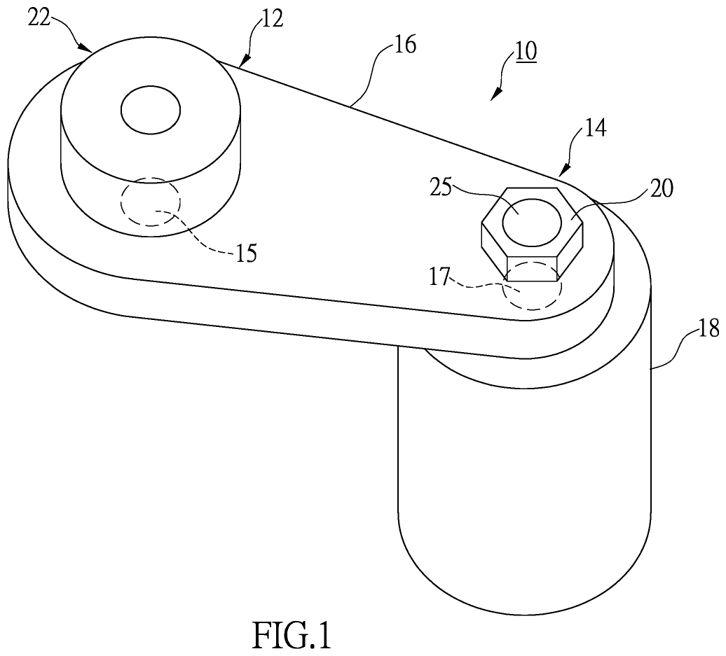

As shown in FIG. 1, the restriction device 10 of the present invention comprises a bridge 16 which includes a connection portion 12 and a locking portion 14 respectively formed on two ends thereof. The bridge 16 is an elongate board that has a certain thickness and includes a first hole 15 and a second hole 17 defined therein. The connection portion 12 has a protrusion 22 which extends perpendicularly from the first side of the bridge 16. The protrusion 22 is adapted to be connected to the connection parts 38 on the brake rotor 30. The locking portion 14 includes a tubular part 18 which is perpendicularly connected to the second side of the bridge 16. The tubular part 18 is to be in contact with the brake caliper 32 to restrict rotation of brake disk 31. The first hole 15 is located corresponding to the protrusion 22, and the second hole 17 is located corresponding to the tubular part 18. The protrusion 22 of the connection portion 12 is connected to one of the connection parts 38 on the hub 36.

The tubular part 18 includes a locking member 25 which extends through the second hole 17 and is locked by a nut 20. The brake disk 31 is restricted from rotating when the tubular part 18 contacts the brake caliper 32.

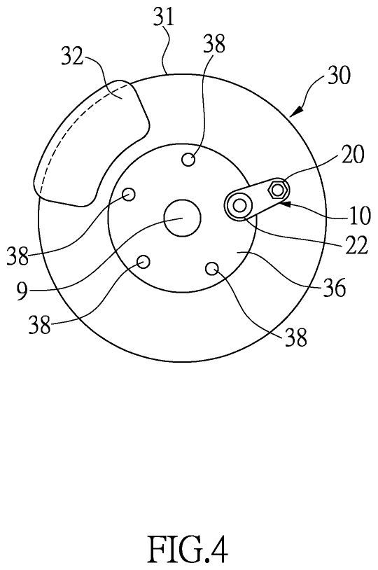

When unscrewing the bolts of the axle 9 and the differential 8, the axle 9 freely rotates and this may affect the maintenance processes. As shown in FIG. 4, when removing the bolts and nuts that connecting the center of the brake disk 31 to the axle 9, the brake disk 31 and the axle 9 rotate freely as well. Although the technician can use a wrench to control the rotation of the brake disk 31, but this is not an easy job. The same problem is expected when removing the bolts connecting the axle 9 and the differential 8. Therefore, it requires two technicians to do the task. On the contrary, only one technician is required when using the restriction device 10 of the present invention.

When using the restriction device of the present invention, the wheel is removed and the connection parts 38 are exposed. The tubular part 18 is located between the hub 36 of the disk body 34 and the brake caliper 32, and the protrusion 22 is connected to one of the connection parts 38 and secured by a nut as shown in FIG. 4.

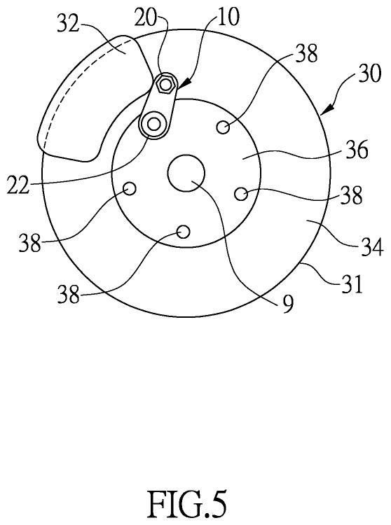

The bolts connecting the axle 9 and the differential 8 are then rotated, and the brake disk 31 is therefore rotated an angle. The base 18 then contacts one of two ends of the caliper 32 as shown in FIG. 5. Because the tubular part 18 is stopped by the caliper 32, the axle 9 and the brake disk 31 now do not rotate. Therefore, the bolts connecting the shaft 9 and the differential 8 can be easily unscrewed.

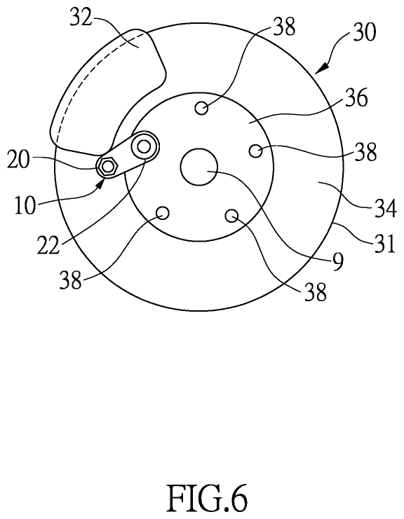

After the maintenance, and the bolts are rotated in reverse direction to fasten the axle 9 to the differential 8, the brake disk 31 will rotate, and the tubular part 18 is moved to another position to contact the other one of the two ends of the caliper 32 as shown in FIG. 6. Therefore, the brake disk 31 is restricted from rotating, and the axle 9 does not rotate either. The bolts connecting the shaft 9 and the differential 8 can be easily fastened and connected to the nuts. After the task is finished, the nut 20 on the locking portion 14 is removed, the restriction device 10 can then be removed from the brake disk 31. Only one technician is required when using the restriction device 10 of the present invention.

While we have shown and described the embodiment in accordance with the present invention, it should be clear to those skilled in the art that further embodiments may be made without departing from the scope of the present invention.

What is claimed is:

1. A restriction device for restricting brake rotor from rotating, the brake rotor including a brake disk, the brake disk including a disk body and a hub which protrudes axially from a center of the disk body, a brake caliper being mounted to outside of the disk body and overlapped a portion of the disk body, the brake caliper cooperated with brake pads which are located between the brake disk and the brake caliper, the hub including multiple connection parts, the restriction device comprising:
a bridge including a connection portion and a locking portion respective formed on two ends thereof, the connection portion having a protrusion which extends from a first side of the bridge and adapted to be connected to connection parts on the hub, the locking portion having a tubular part which is connected to a second side of the bridge, the tubular part configured to be located between the hub of the disk body and the brake caliper, the tubular part configured to contact one of two ends of the brake caliper to restrict rotation of brake disk.

2. The restriction device as claimed in claim 1, wherein a locking member extends through the bridge and is connected to the tubular part.

3. The restriction device as claimed in claim 1, wherein the bridge includes a first hole and a second hole defined therein, the first hole is located corresponding to the protrusion, the second hole is located corresponding to the tubular part, a locking member extends through the second hole and is connected with a nut.
